(19) United States
(12) Patent Application Publication
(10) Pub. No.: US 2024/0399697 A1
(43) Pub. Date: Dec. 5, 2024

(54) WICKETED ENVELOPES

(71) Applicant: Pregis Innovative Packaging LLC, Bannockburn, IL (US)

(72) Inventor: Thomas D. Wetsch, Naples, FL (US)

(21) Appl. No.: 18/734,728

(22) Filed: Jun. 5, 2024

Related U.S. Application Data
(60) Provisional application No. 63/610,342, filed on Dec. 14, 2023.
(60) Provisional application No. 63/506,280, filed on Jun. 5, 2023.

(51) Int. Cl. B31B 70/81; B31B 160/10

(52) U.S. Cl. CPC B31B 70/81; B31B 2160/10

(57) ABSTRACT

Container units configured to be held on a wicket can include an envelope having flexible walls fixed to each other and defining a pocket for holding an item, and a wicketing flap connected to one of the flexible walls and configured to engage a wicket to suspend the wicketed packaging device from the wicket. The wicketing flap can detach from the envelope in response to a force exerted on the envelope, and can remain engaged with the wicket upon separating from the envelope. The wicketing flaps of a plurality of the container units can be connected to form a wicketing spine that helps to distribute the pulling force exerted on one of the container units to at least some of the other container units.

### CROSS-REFERENCE TO RELATED APPLICATIONS

The present application claims priority of U.S. Patent Application No. 63/506,280, filed Jun. 5, 2023, and U.S. Patent Application No. 63/610,342, filed Dec. 14, 2023, the contents of which are incorporated by reference herein in their entirety.

### FIELD

The present disclosure relates generally to packaging for holding items, for example, during shipping. More specifically, the present disclosure relates to envelopes configured to be held on and dispensed from a wicket.

### BACKGROUND

Poly bags, i.e., bags made of plastics such as polyethylene and polystyrene, are in widespread use to mail small to mid-sized items due, in part, to the ability of such bags to withstand tearing and other damage that can occur during shipping, and to conform to the shape of the item being packaged therein. In some applications, a plurality of poly bags can be suspended on a wire frame or wicket in a vertically or horizontally-stacked arrangement. When needed, an individual bag can be removed from the wicket by pulling the bag so that the bag material is torn by the wicket, thereby freeing the bag from the wicket.

The use of shipping envelopes formed from paper has been growing in popularity in relation to poly bags due to the recyclability of paper. Configuring paper envelopes in a wicketed arrangement, however, can present challenges. For example, the tearing of the envelope that occurs when envelope is removed from the wicket can damage the flap or other portions of the envelop that are needed to close and seal the envelope, which in turn can interfere with the ability of the envelope to properly contain and protect the items being held therein.

### SUMMARY

In one aspect of the disclosed technology, a flight of envelopes includes a plurality of container units, each having an envelope. The incudes a first flexible wall, and a second flexible wall overlying the first flexible wall and fixed to the first flexible wall about at least a portion of a pocket border. The pocket border encloses a pocket defined between the walls and configured and dimensioned to contain an item. At least one of the walls defines a pocket opening allowing access to the pocket from an exterior of the envelope for loading the item into the pocket.

Each container unit also includes a wicketing flap removably connected to the envelope. The wicketing flaps of the plurality of container units are affixed to each other to cumulatively define a wicketing spine, such that the spine has an elevated rigidity and resistance to tearing in relation to a single one of the wicketing flaps.

In another aspect of the disclosed technology, the spine is configured to distribute at least a portion of a force exerted on one of the container units to the wicketing flaps of at least some of the other container units.

In another aspect of the disclosed technology, the force is a pulling force.

In another aspect of the disclosed technology, the spine is configured to be held on a wicket, and the wicketing flap is configured to detach from the first flexible wall in response to the pulling force, where the pulling force is exerted on one or both of the first and second flexible walls in a direction away from the wicket.

In another aspect of the disclosed technology, the wicketing flap is configured to engage a wicket to suspend the container unit from the wicket, and to remain engaged with the wicket upon separating from the envelope.

In another aspect of the disclosed technology, the envelope is flexible.

In another aspect of the disclosed technology, the wicketing flap is removably connected to the first wall.

In another aspect of the disclosed technology, the wicketing flaps of the plurality of container units are configured to be stacked to further cumulatively define the wicketing spine.

In another aspect of the disclosed technology, the flight of wicketed envelopes further includes at least five of the container units.

In another aspect of the disclosed technology, the flight of wicketed envelopes further includes at least ten of the container units.

In another aspect of the disclosed technology, the flight of wicketed envelopes further includes at least twenty of the container units.

In another aspect of the disclosed technology, the spine has a thickness about equal to a combined thickness of the wicketing flaps of the plurality of container units.

In another aspect of the disclosed technology, the envelope further includes a closure flap that adjoins, and is disposed between the first flexible wall and the wicketing flap. The wicketing flap is removably connected to the closure flap. The closure flap is configured to rotate from a first position, to a second position at which the closure flap covers the pocket opening to retain the item in the pocket.

In another aspect of the disclosed technology, the envelope further includes a sealing element disposed on at least one of the closure flap and the second flexible wall. The sealing element is configured to form a closure seal that fixes the closure flap to the second flexible wall when the closure flap is in the second position.

In another aspect of the disclosed technology, the pocket is sealed on a first, a second, and a third side of the pocket, and is open on a fourth side of the pocket when the closure flap is in the first position. The pocket is sealed on the first, second, third, and fourth sides of the pocket when the closure flap is fixed in the second position by the closure seal.

In another aspect of the disclosed technology, the envelope further includes a sealing element disposed on at least one of the first flexible wall and the second flexible wall. The sealing element is configured to form a closure seal that fixes the first flexible wall to the second flexible wall.

In another aspect of the disclosed technology, the pocket is sealed on a first, a second, and a third side of the pocket, and is open on a fourth side of the pocket prior to formation of the closure seal. The pocket is sealed on the first, second, third, and fourth sides of the pocket when the first flexible wall is fixed to the second flexible wall by the closure seal.

In another aspect of the disclosed technology, the wicketing flaps of the plurality of container units are connected by at least one of a staple, a clamp, and an adhesive.

In another aspect of the disclosed technology, the at least one of a staple, a clamp, and an adhesive is configured to transmit at least a portion of the force to the wicketing flaps of the other container units.

In another aspect of the disclosed technology, at least one of the first and second flexible walls includes paper.

In another aspect of the disclosed technology, the container units are configured to be stacked within the flight.

In another aspect of the disclosed technology, the container units are configured to be stacked within the flight in a substantially flat configuration.

In another aspect of the disclosed technology, the wicketing flap has at least one hole formed therein and configured to receive a portion of the wicket.

In another aspect of the disclosed technology, the wicketing flap has at least two of the holes formed therein. The holes are configured to receive a respective first and second leg of the wicket.

In another aspect of the disclosed technology, the wicketing spine is further configured to resist a reactive force exerted by the wicket on the wicketing spine in response to the force.

In another aspect of the disclosed technology, the wicketing spine is further configured to hold each of the wicketing flaps in contact with one or more adjacent wicketing flaps within the flight of wicketed flaps.

In another aspect of the disclosed technology, a region of weakness is defined between the wicketing flap and the envelope. The region of weakness is configured to facilitate separation of the wicketing flap from the envelope.

In another aspect of the disclosed technology, the region of weakness is defined by perforations.

In another aspect of the disclosed technology, the envelope further incudes a gusset connecting edges the first and second flexible walls and configured to allow the first and second flexible walls to move toward and away from each other.

In another aspect of the disclosed technology, at least one of the first and second flexible walls includes a first layer and a second layer fixed to the first layer.

In another aspect of the disclosed technology, the first layer includes a first ply of paper.

In another aspect of the disclosed technology, the second layer includes a second ply of paper.

In another aspect of the disclosed technology, the first ply is fixed to the second ply by a plurality of inter-ply seals, and the inter-ply seals border an inter-ply space defined by the first and second plies.

In another aspect of the disclosed technology, the inter-ply seals include a sealing element, and the inter-ply-space is free of the sealing element.

In another aspect of the disclosed technology, the flight of wicketed envelopes further includes at least one of a cushioning, padding, and/or thermally-insulating material disposed within the inter-ply space.

In another aspect of the disclosed technology, the at least one of a cushioning, padding, and/or thermally-insulating material is an expandable material.

In another aspect of the disclosed technology, a container unit configured to be held on a wicket includes an envelope having first flexible wall, and a second flexible wall overlying the first flexible wall and fixed to the first flexible wall about at least a portion of a pocket border. The pocket border encloses a pocket defined between the walls and configured and dimensioned to contain an item. At least one of the walls defines a pocket opening allowing access to the pocket from an exterior of the envelope for loading the item into the pocket. The container unit also includes a wicketing flap removably connected to the envelope.

In another aspect of the disclosed technology, a supply unit of container units configured to be held on a wicket includes a wicket, and a plurality of the above container units.

In another aspect of the disclosed technology, the wicketing flap is configured to detach from the first flexible wall in response to a force exerted the container unit.

In another aspect of the disclosed technology, the force is a pulling force.

In another aspect of the disclosed technology, the wicketing flap is configured to engage the wicket to suspend the container unit from the wicket, and to remain engaged with the wicket upon separating from the envelope.

In another aspect of the disclosed technology, the envelope is flexible.

In another aspect of the disclosed technology, the wicketing flap is removably connected to the first wall.

In another aspect of the disclosed technology, the envelope further includes a closure flap that adjoins, and is disposed between the first flexible wall and the wicketing flap. The wicketing flap is removably connected to the closure flap, and the closure flap is configured to rotate from a first position, to a second position at which the closure flap covers the pocket opening to retain the item in the pocket.

In another aspect of the disclosed technology, the envelope further includes a sealing element disposed on at least one of the closure flap and the second flexible wall, and the sealing element is configured to form a closure seal that fixes the closure flap to the second flexible wall when the closure flap is in the second position.

In another aspect of the disclosed technology, the pocket is sealed on a first, a second, and a third side of the pocket, and is open on a fourth side of the pocket when the closure flap is in the first position. The pocket is sealed on the first, second, third, and fourth sides of the pocket when the closure flap is fixed in the second position by the closure seal.

In another aspect of the disclosed technology, the envelope further includes a sealing element disposed on at least one of the first flexible wall and the second flexible wall, and the sealing element is configured to form a closure seal that fixes the first flexible wall to the second flexible wall.

In another aspect of the disclosed technology, the pocket is sealed on a first, a second, and a third side of the pocket, and is open on a fourth side of the pocket prior to formation of the closure seal. The pocket is sealed on the first, second, third, and fourth sides of the pocket when the first flexible wall is fixed to the second flexible wall by the closure seal.

In another aspect of the disclosed technology, at least one of the first and second flexible walls includes paper.

In another aspect of the disclosed technology, a region of weakness is defined between the wicketing flap and the envelope. The region of weakness is configured to facilitate separation of the wicketing flap from the envelope.

In another aspect of the disclosed technology, the region of weakness is defined by perforations.

In another aspect of the disclosed technology, the envelope further includes a gusset connecting edges the first and second flexible walls and configured to allow the first and second flexible walls to move toward and away from each other.

In another aspect of the disclosed technology, at least one of the first and second flexible walls includes a first layer and a second layer fixed to the first layer

In another aspect of the disclosed technology, the first layer includes a first ply of paper.

In another aspect of the disclosed technology, the second layer includes a second ply of paper.

In another aspect of the disclosed technology, the first ply is fixed to the second ply by a plurality of inter-ply seals, and the inter-ply seals border an inter-ply space defined by the first and second plies.

In another aspect of the disclosed technology, the inter-ply seals includes a sealing element, and the inter-ply-space is free of the sealing element.

In another aspect of the disclosed technology, the container unit further includes at least one of a cushioning, padding, and/or thermally-insulating material disposed within the inter-ply space.

In another aspect of the disclosed technology, the at least one of a cushioning, padding, and/or thermally-insulating material is an expandable material.

In another aspect of the disclosed technology, a method of packaging an item includes providing a container unit configured to be held on a wicket. The container unit includes an having a first flexible wall, and a second flexible wall opposing the first flexible wall. The first and second flexible walls define a pocket therebetween. The container unit alos includes a sealing element configured to from a closure seal that maintains the pocket opening in a closed condition, and a wicketing flap connected to the closure flap.

The method also includes suspending the container unit from a wicket by way of the wicketing flap, loading an item into the pocket, detaching the envelope from the wicketing flap, and forming the closure seal.

In another aspect of the disclosed technology, the wicketing flap is connected to, and adjoins the first flexible wall, and detaching the envelope from the wicketing flap includes detaching the first flexible wall from the wicketing flap.

In another aspect of the disclosed technology, the sealing element is disposed on the first flexible wall, and the closure seal is configured to fix the first flexible wall to the second flexible wall.

In another aspect of the disclosed technology, the envelope further includes a closure flap connected to, and adjoining the first flexible wall and the wicketing flap. The closure flap is configured to rotate from a first position to a second position.

In another aspect of the disclosed technology, detaching the envelope from the wicketing flap includes detaching the closure flap from the wicketing flap.

In another aspect of the disclosed technology, the method further includes moving the closure flap from the first to the second position after detaching the envelope from the wicketing flap. The sealing element is disposed on one of the closure flap and the second flexible wall, and the closure seal is configured to secure the closure flap to the second flexible wall.

### BRIEF DESCRIPTION OF THE DRAWINGS

The following drawings are illustrative of particular embodiments of the present disclosure and therefore do not limit the scope of the present disclosure. Embodiments of the present disclosure will hereinafter be described in conjunction with the appended drawings, wherein like numerals denote like elements.

FIG. 1 is an exploded, perspective view of an embodiment a supply unit of wicketed envelopes;

FIG. 2 is a perspective view of one container unit of the supply unit of FIG. 1, with an envelope of the container unit attached to a wicketing flap of a container unit;

FIG. 3 is a front view of one of the container units that is shown wicketed in FIG. 1;

FIG. 4 is a front view of two plies of a web of the container unit shown in FIG. 3, in an unassembled state;

FIG. 5 is a front view of two plies of a wall of the container unit shown in FIG. 3, in an unassembled state;

FIG. 6 is a front view of the web and the wall of the container unit shown in FIG. 3, in an unassembled state;

FIG. 7 is a cross-sectional bottom view taken through the line “VII-VII” of FIG. 3, not shown to scale for clarity of illustration;

FIG. 8 is a cross-sectional side view taken through the line “VIII-VIII” of FIG. 3;

FIG. 9 is a perspective view of the supply unit shown in FIG. 1, showing the supply unit mounted on a backboard, and showing an envelope in an open and loaded state and separated from its corresponding wicketing flap;

FIG. 10 is a perspective view of the separated and loaded envelope of FIG. 9, with its closure flap sealed in a closed position;

FIG. 11 is a bottom view of the container unit shown in FIG. 3;

FIG. 12 is a perspective view of a flight of the supply unit of FIG. 1, with a clamp disposed on a wicketing spine of the flight;

FIG. 13 is a perspective view of a supply unit of an alternative embodiment of the container unit of FIG. 3;

FIG. 14 is a top perspective view of another embodiment of the container unit of FIG. 3;

FIG. 15 is a cross-sectional view of the container unit shown in FIG. 14, taken through the line “XV-XV” of FIG. 14.

FIG. 16 is a side by side view of a web and a wall of the container unit shown in FIGS. 14 and 15, prior to the wall being fixed to the web; and

FIG. 17 is a side by side view of a first and a second ply of the web shown in FIG. 16, prior to the second ply being fixed to the first ply.

### DETAILED DESCRIPTION

The inventive concepts are described with reference to the attached figures, wherein like reference numerals represent like parts and assemblies throughout the several views. Several aspects of the inventive concepts are described below with reference to example applications for illustration. It should be understood that numerous specific details, relationships, and methods are set forth to provide a full understanding of the inventive concepts. One having ordinary skill in the relevant art, however, will readily recognize that the inventive concepts can be practiced without one or more of the specific details or with other methods. In other instances, well-known structures or operation are not shown in detail to avoid obscuring the inventive concepts.

The inventive concepts are described with reference to the attached figures, wherein like reference numerals represent like parts and assemblies throughout the several views. Several aspects of the inventive concepts are described below with reference to example applications for illustration. It should be understood that numerous specific details, relationships, and methods are set forth to provide a full understanding of the inventive concepts. One having ordinary skill in the relevant art, however, will readily recognize that the inventive concepts can be practiced without one or more of the specific details or with other methods. In other instances, well-known structures or operation are not shown in detail to avoid obscuring the inventive concepts.

Envelopes can include parcel packaging and other containers to package items. Envelopes are configured to contain and hold an item, typically enclosing the item, during shipping or storage of the item. Parcel packaging is configured for shipping and/or storing products, such as for storage in warehouse or retail shelves and displays. Examples of parcel packaging include flexible shipping containers such as envelopes, which can have varying degrees of flexibility and typically are used to ship or mail small or relatively flat items or smaller items around which the walls of the envelope can conform. Flexible shipping containers such as envelopes can be padded or non-padded, can be made of materials such as paper and flexible cardboard, can be configured with or without sidewalls or gussets, and can include larger envelopes such as mailers. Examples of parcel packaging also include bags, such as paper or poly bags, which can have a self-sealing capability and are typically used to ship small to medium-sized items; boxes, which can be formed from paperboard, cardboard, wood, or plastic, and typically have a rigid or semi-rigid structure suitable for holding medium to large-size items and heavier items; and shipping tubes or tube mailers, typically used to ship documents and paper items.

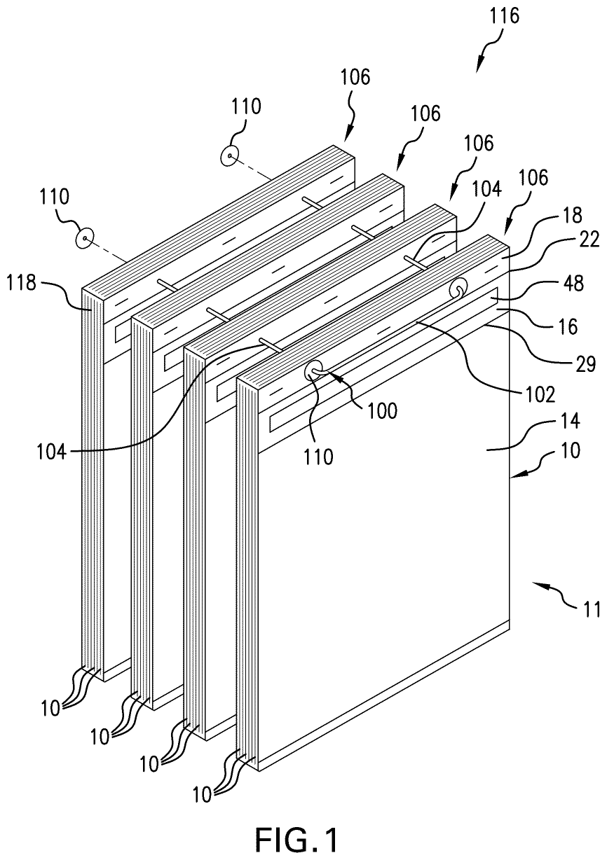

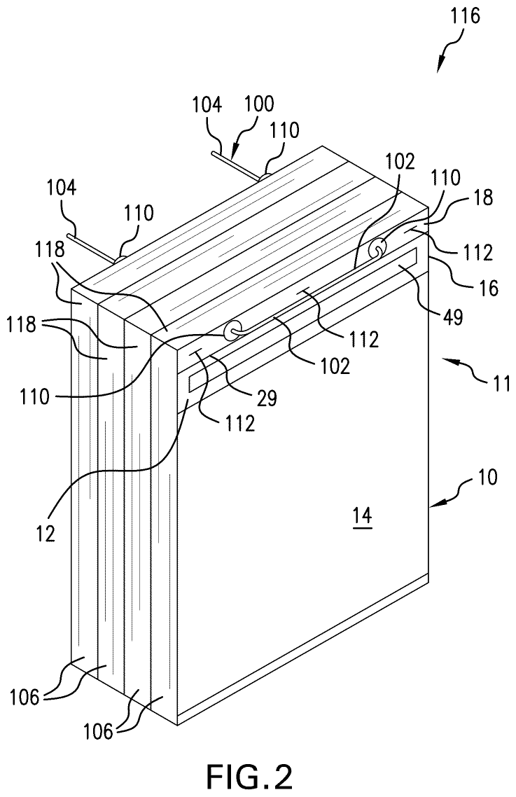

FIGS. 1, 2, and 9 depict a plurality of wicketed envelopes 10. Each envelope 10 is attached to a wicketing flap 18. The envelope 10 and the wicketing flap 18 together form a container unit 11. The container units 11 can be held on a wicket wire, or wicket 100.

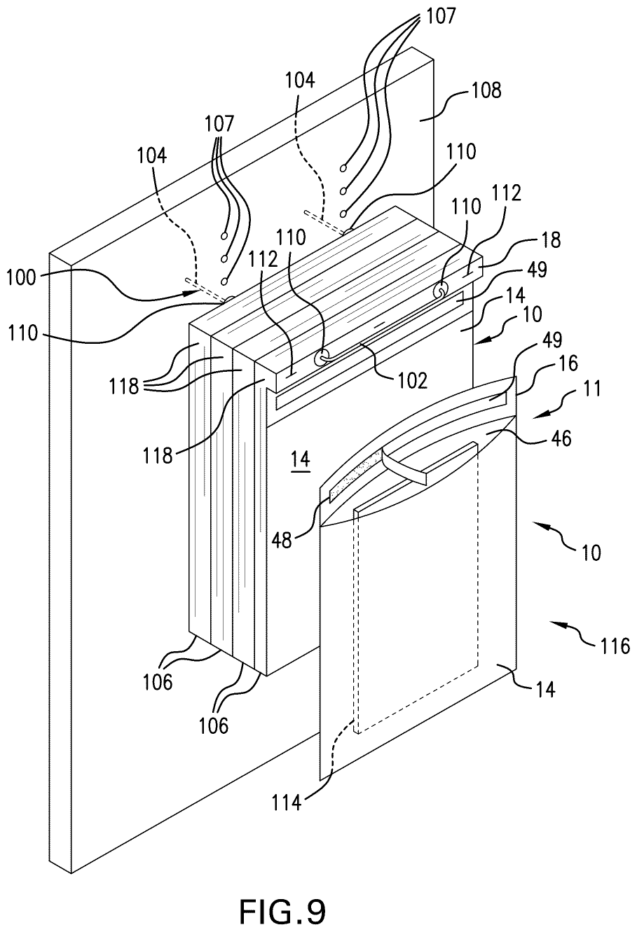

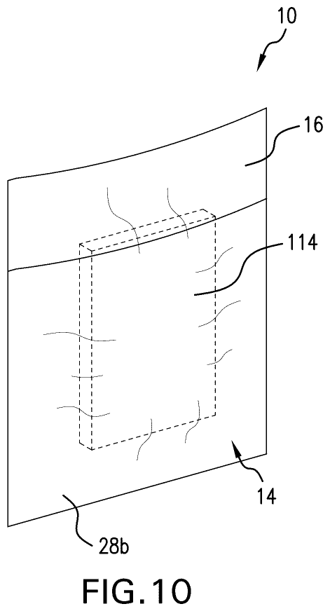

The container units 11 and the wicket 100 together form a supply unit 116 of wicketed envelopes 10. The envelopes 10 are configured to contain and hold an item to be packaged 114, typically enclosing the item 114, while the item 114 is being mailed or shipped, or otherwise needs to be packaged in a closed container. The item 114 is depicted phantom in FIGS. 9 and 10. As discussed below, the envelope 10 can be detached from the wicketing flap 18 manually, or using automated equipment, after the item 114 has been loaded into the envelope 10, with the wicketing flap 18 remaining on the wicket 100.

The term “envelope,” as used herein, is intended to encompass, without being limited to, flat shipping containers, including mailers, typically used to ship or mail smaller items and having sufficient flexibility so as to expand and bend around the item 114 upon insertion of the item 114 into a pocket within the envelope; and in which the sidewalls or thickness of the container are substantially smaller than, e.g., less than 1/100^{th} (one percent) of, the width and/or height of the container.

Referring to FIGS. 1, 2, and 9, the wicket 100 includes a rigid cross member 102, and two rigid legs 104. The legs 104 adjoin opposite ends of the cross member 102, and are substantially perpendicular to the cross member 102, giving the wicket 100 a substantially U-shaped configuration. The container units 11 are arranged in groupings, or flights 106 within which the container units 11 are attached to each other as discussed below. Each flight 106 includes ten container units 11. Each flight 106 can includes less, or more than ten container units 11 in the alternative. For example, in other embodiments, each flight 106 can include five container units 11. In other embodiments, each flight 106 can include, for example, twenty or more container units 11.

The wicket 100 can be configured to hold four of the flights 106. The wicket 100 can be configured to hold less, or more than four flights 106 in the alternative.

In one possible application, the wicket 100 can be mounted on a backboard 108 of a packing table, so that a packaging operator can remove an individual envelope 10 from the wicket 100 when an envelope 10 is needed to package the item 114. The backboard 108 is depicted in FIG. 9. The freestanding ends of the legs 104 can engage holes 107 or other mounting provisions on the backboard 108 so that the wicket 100 is suspended, and extends outwardly from the backboard 108. This particular application is disclosed for illustrative purposes only. The wicket 100 can be installed on other mounting structures, including a wall or an automated packaging apparatus, using other mounting features, in the alternative. Also, the wicket 100 can have configurations other than the configuration disclosed herein. For example, alternative embodiments of the wicket 100 can be configured as a single piece of flexible or semi-rigid wire, with the ends thereof configured to engage the mounting structure. Other alternative embodiments can be configured with hooks or other provisions at the freestanding end of each leg 104, for engaging complementary mounting provisions on the mounting structure.

Each container unit 11 can be formed, in whole or in part, from paper, such as kraft paper. Examples of paper suitable for use in forming the container unit 11 include, but are not limited to, kraft paper, fiberboard, pulp-based paper, recycled paper, newsprint, paperboard, etc. In some applications, the paper may be an extensible paper configured to elongate, or stretch, by a percentage of its original (unstretched) length, without tearing. Parameters of the paper, including its dimensions and weight, may be varied depending upon the desired application. For example, the container unit 11 can be formed from kraft paper having a basis weight of 40 pounds. The container unit 11 can be formed from materials other than paper, such as plastic film, in alternative embodiments.

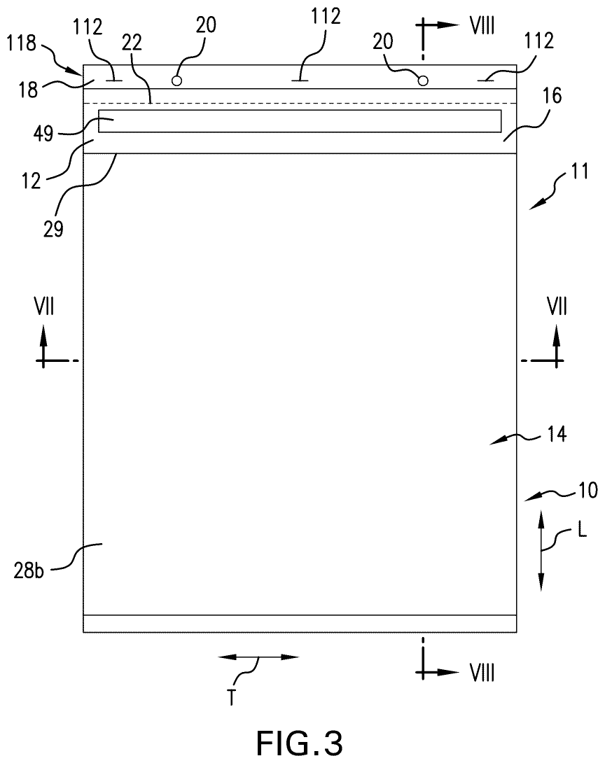

Referring to FIGS. 3 and 10, the envelope 10 of each container unit 11 comprises a flexible wall 12, and a flexible wall 14 fixed to the flexible wall 12 the below-described manner. The walls 12, 14 define a containment region in the form of an envelope pocket 15. The envelope pocket 15 is configured to receive and hold the item to be packaged 114.

The envelope 10 also includes a closure flap 16. A lower end of the closure flap 16 adjoins an upper end of the wall 12. A lower end of the wicketing flap 18 of the container unit 11 adjoins an upper end of the closure flap 16.

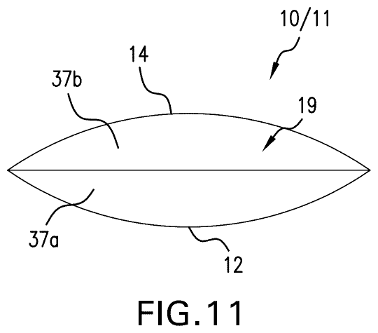

The envelope 10 further includes a gusset 19, shown in FIG. 11, that adjoins the lower ends of the walls 12, 14. The gusset 19 further defines the envelope pocket 15, and facilitates expansion of the envelope 10 by allowing relative movement between the wall 12 and the wall 14. Alternative embodiments of the envelope 10 can be formed without the gusset 19. Other alternative embodiments of the envelope 10 can include longitudinally-extending gussets between the walls 12, 14 in addition to, or in in lieu of the transversely-extending gusset 19.

Directional terms such as “upper,” “lower,” “above,” “below,” etc. are used in relation to the component orientations shown in FIG. 3. These terms are used for illustrative purposes only, and are not intended to limit the scope of the claims.

The wicketing flap 18 has two holes 20 formed therein. Referring to FIGS. 1-3 and 9, each hole 20 receives a respective leg 104 of the wicket 100, so that the container unit 11 is suspended from the wicket 100 by way of the wicketing flap 18. The holes 20 can be disposed symmetrically about the longitudinal centerline of the envelope 10, and can have a center-to-center spacing of, for example, about eight inches. In alternative embodiments, the center-to-center spacing of the holes 20 can be about four inches. These particular values of the center-to-center spacing of the holes 20 are presented for illustrative purposes only. The holes 20 can be spaced by other distances in alternative embodiments.

The uppermost and lowermost portions of each hole 20 can be offset from the respective upper edge and lower edge of the wicketing flap 18 by a distance about equal to the diameter of the hole 20, to reduce the potential for the wicketing flap 18 to tear and separate from the wicket 100 when the envelope 10 is separated from the wicketing flap 18 as discussed below. The holes 20 can be spaced from the upper and lower edges of the wicketing flap 18 by other distances in alternative embodiments.

Two retainers in the form of grommets or washers 110 are disposed on each leg 104 of the wicket 100, as shown in FIGS. 1, 2, and 9. The washers 110 on each leg 104 are located behind, and in front of the flights 106, are retained on the respective legs 104 by friction, and help to retain the flights 106 on the respective legs 104.

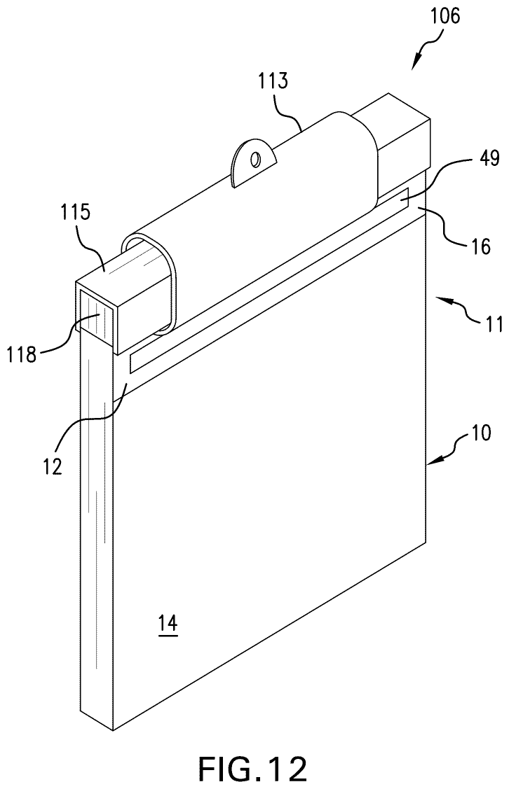

The container units 11 within each flight 106 can be held together by, for example, one or more staples 112 that extend through the wicketing flaps 18 of each container unit 11. The staples 112 are shown in FIGS. 1, 2, and 9. The container units 11 within each flight 106 can be held together by other features in addition to, or in lieu of the staples 112. For example, FIG. 12 depicts the container units 11 of one flight 106 being held together by a clamp 113 that grasps the wicketing flaps 18 of the container units 11 by way of a protective layer 115 formed from paper or another suitable material. In other embodiments, the wicketing flaps 18 can be held together by an adhesive, fasteners other than staples, etc.

The wicketing flaps 18 of each flight 106 collectively form a wicketing spine 118 for the flight 106. Because the wicketing flaps 18 within the flight 106 are connected to each other by the staples 112, clamp 113, and/or other provisions, forces exerted on one the wicketing flaps 18 are distributed to the other wicketing flaps 18 in the flight 106. The wicketing spine 118 thus acts as a rigid or semi-rigid structure through which external forces acting on one or more of the container units 11 can be transmitted to the wicket 100. Conversely, the reactive force exerted by the wicket 100 is distributed throughout the wicketing spine 118.

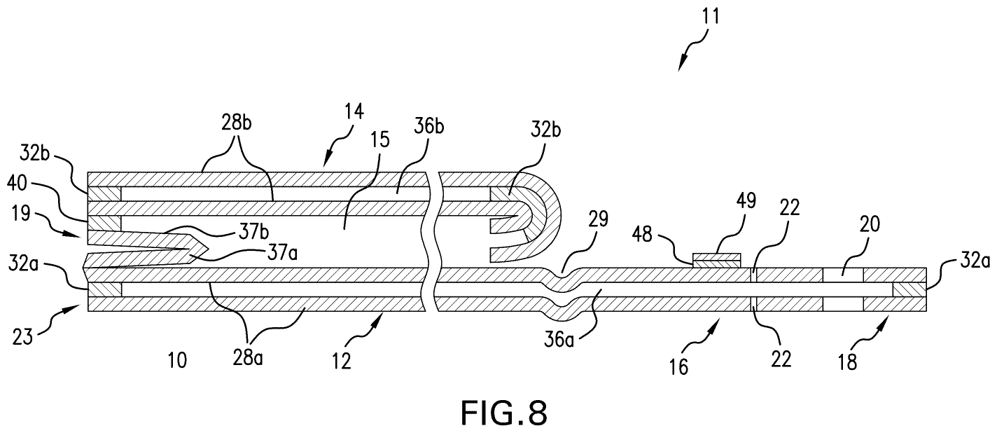

In the disclosed embodiment of the container unit 11, the envelope 10 is configured to separate from the wicketing flap 18 by the provision of a region of weakness between the closure flap 16 and the wicketing flap 18. The region of weakness permits the closure flap 16 to be torn or otherwise separated from the wicketing flap 18, for example, when the packaging operator wishes to remove the envelope 10 from the wicket 100. The region of weakness can be provided, for example, by perforations 22, visible in FIGS. 3 and 8. Each perforation 22 can have a length of, for example, about 0.75 inch, and can be separated from its adjacent perforation 22 by, for example, about 0.03 inch. These values are presented for illustrative purposes only. The optimal length and separation distance of the perforations 22 is application-dependent, and can vary with factors such as the thickness of the material from the which the envelope 10 is formed, the desired amount of force need to separate the closure flap 16 from the wicketing flap 18, etc. In alternative embodiments, the container unit 11 can be equipped with a pull tab or other provision in lieu of the perforations 22, to facilitate separation of the envelope 10 from the wicketing flap 18.

In alternative embodiments, the region of weakness can be provided by features other than the perforations 22. For example, the region of weakness can be provided by a score line. Other alternative embodiments can be configured without a line of weakness. In such embodiments, the closure flap 16 can be separated from the wicketing flap 18 by cutting, tearing, the focused application of heat, etc. In other alternative embodiments, the container unit 11 can be equipped with a pull tab or other provision in lieu of the perforations 22.

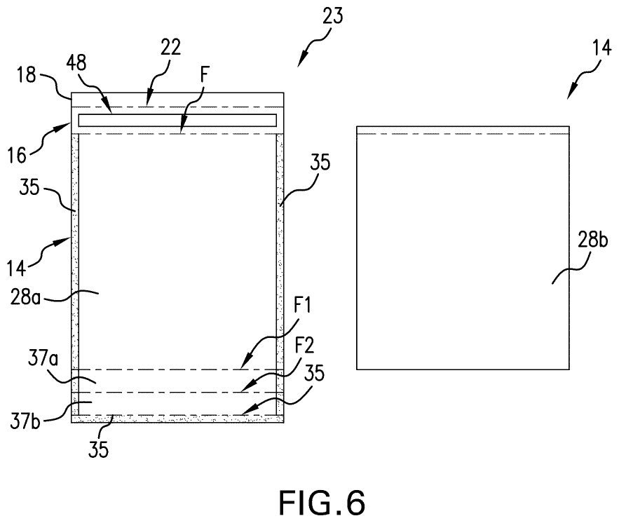

The wall 12 can be formed unitarily with the closure flap 16, the wicketing flap 18, and the gusset 19. The wall 12, the closure flap 16, the wicketing flap 18, and the gusset 19 can be formed from a two-layer web 23, depicted in FIGS. 6-8. Each layer of the two-layer web 23 is made of a single ply 28a of paper. The wall 14 likewise includes two layers, with each layer of the two-layer wall 14 being formed by a single ply 28b of paper. The wall 14 can be fixed to the web 23 in the below-described manner, to form the assembled envelope 10.

The paper from which the plies 28a, 28b are formed can be, for example, kraft paper having a basis weight of 40 pounds. In alternative embodiments, one or both of the web 23 and the wall 14 have a single-layer configuration. The plies 28a, 28b can be formed from paper other than kraft paper, from paper having a basis weight greater or less than 40 pounds, and from materials other than paper, such as plastic film, in alternative embodiments.

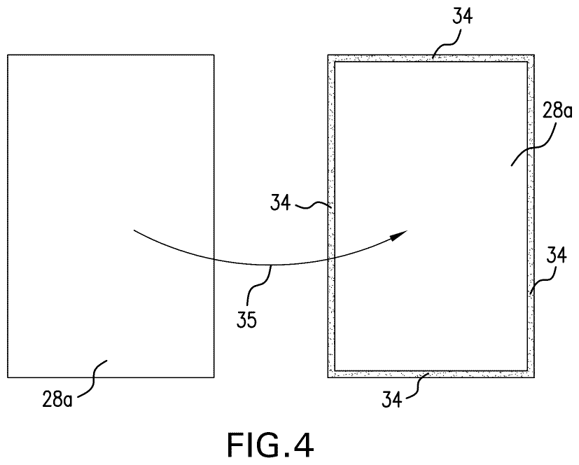

Referring to FIGS. 4 and 6-8, the plies 28a of the web 23 are fixed to each other by two longitudinal inter-ply seals 30a and two transverse inter-ply seals 32a. The longitudinal and transverse inter-ply seals 30a, 32a are formed from a sealing element in the form of an adhesive material 34. The adhesive material 34 is applied to a first of the plies 28a as shown in FIG. 4. The other ply 28a is aligned with the first ply 28a and brought into contact with the adhesive material 34, as denoted by the arrow 39 in FIG. 4, to form the longitudinal and transverse inter-ply seals 30a, 32a, thereby fixing the plies 28a to each other to form the web 23. In alternative embodiments, the web 23 can be formed as part of a continuous webbing containing multiple webs 23. The individual plies 28a within the webbing can be formed from two continuous sheets of paper fixed to each other by the adhesive material 34 applied to the sheets of paper so as to form the longitudinal and transverse inter-ply seals 30a, 32a when the sheets are aligned and brought into contact with each other. Each individual web 23 can be cut from the webbing before, or after the web 23 is joined with a corresponding wall 14 to form the envelope 10.

The longitudinal and transverse directions are denoted in the figures by the respective arrows “L” and “T.”

Each longitudinal inter-ply seal 30a is located along a corresponding longitudinal, or side edge of the web 23, and extends along the entire length of the web 23. Each longitudinal inter-ply seal 30a can be offset from the corresponding side edge of the web 23 in alternative embodiments. The longitudinal inter-ply seals 30a are continuous. The longitudinal inter-ply seals 30a can be non-continuous in alternative embodiments.

The transverse inter-ply seals 32a are located along the upper and lower edges of the web 23, and extend substantially in a transverse direction, between the longitudinal inter-ply seals 30a. The transverse inter-ply seals 32a can be offset from the upper and lower edges of the web 23 in alternative embodiments.

The transverse inter-ply seals 32a are continuous. The transverse inter-ply seals 32a can be non-continuous in alternative embodiments. In other alternative embodiments, the transverse inter-ply seals 32a can extend across the entire width of the web 23, and the longitudinal inter-ply seals 30a can extend between the transverse inter-ply seals 32a.

The adhesive material 34 can be a cold glue. Other types of adhesive materials, and other types of sealing elements can be used in lieu of a cold glue alternative embodiments. For example, the adhesive 34 can be a cohesive material, a heat sealable material, and/or a hot-melt adhesive in alternative embodiments.

The sealing element, e.g., the adhesive material 34, can be applied directly to the exposed surface of the first ply 28a, by suitable known methods. Alternatively, the sealing element can be applied as a tape, such as a double-sided tape, or by other suitable methods.

The adhesive 34 can be, for example, a liquid adhesive or a pressure-sensitive adhesive. Pressure sensitive adhesives stick to create the bond upon the application of a slight, initial, external pressure to the adhesive. Pressure sensitive adhesives includes water-based, acrylic, pressure sensitive adhesives. Specific examples of such adhesives include RHOPLEX™ N-1031 Emulsion, RHOPLEX™ N-580 Emulsion, and RHOPLEX™ N-619 Emulsion. Other emulsion polymers or acrylic polymer blend adhesives are also known, and other suitable types of adhesives and/or contact adhesives can be used. Pressure sensitive adhesives also include dry adhesives, which typically require no activation with water, solvent or heat, and firmly adhere to many dissimilar surfaces.

In the alternative, the adhesive 34 can be, for example, a cohesive material. A cohesive material includes a bonding material that causes one surface to stick to an opposing surface by coming into contact with the same or a complimentary cohesive substance to form the bond between the two surfaces. Cohesives do not stick to other substances sufficiently to adhere to those other substances, or in some cases stick very weakly compared to the bond they form from sticking to each other.

In the alternative, the adhesive 34 can be, for example, a heat-sealable material. A heat seal may be formed between the same or similar types of thermoplastic materials by subjecting the materials to heat and pressure sufficient to weld the materials to each other. In the case of paper substrates to be fixed to each other, a heat sealable material may be applied to each of the substrates. At the time the substrates are to be fixed, the heat sealable material on one or both of the substrates is subject to heat and pressure sufficient to weld the heat sealable materials together, thereby fixing the paper substrates to each other.

In the alternative, the adhesive 34 can be, for example, a hot-melt adhesive. Hot-melt adhesives are thermoplastic polymers that are solid at room temperature, become molten when heated to a temperature above their softening point, and resolidify by loss of heat, increasing in strength as they resolidify. Most hot-melt adhesives, upon melting into a molten state and re-solidifying, do not undergo any chemical reaction such as cross-linking or removal of a carrier, e.g., evaporation of water. Thus, hot-melt adhesives typically can be re-activated, i.e., re-melted and re-solidified, after initially being applied to a substrate.

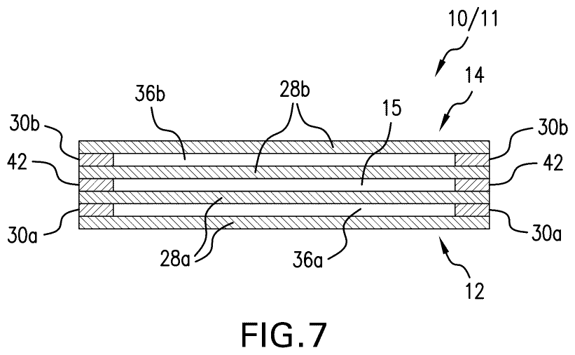

The longitudinal and transverse inter-ply seals 30a, 32a border, and help to define an interlayer region, or inter-ply space 36a between the two plies 28a of the web 23. The inter-ply space 36a is visible in FIGS. 7 and 8.

The plies 28a face each other each other across the inter-ply space 36a, but are not adhered to each other in the inter-ply space 36a. Also, the inter-ply space 36a is sufficiently empty such that the plies 28a can abut and otherwise contact each other within the inter-ply space 36a, and can slide in relation to each other within the inter-ply space 36a. For example, the inter-ply space 36a can be completely empty, i.e., the inter-ply space 36a can be completely devoid of any filler or other material.

In alternative embodiments, a cushioning, padding, and/or thermally-insulting material, or other types of expandable and non-expandable materials can be disposed in the inter-ply space 36a. For example, a foam padding material can be disposed in the inter-ply space 36a. As another example, an expansion material can be disposed in the inter-ply space 36a, and can be adhered to one or both of the plies 28a. The expansion material is configured to assume an expanded configuration upon activation by an expansion initiator. The expansion initiator can be, for example, thermal, mechanical, and/or chemical, and/or can include other suitable initiating properties for activating the expansion material. The expansion material, in its expanded state, can provide the envelope 10 with cushioning, thermally-insulative, or other properties.

One or more of the plies 28a can include one or more functional layers positioned thereon. Examples of functional layers can include, but are not limited to, waterproofing layers configured to reduce permeability of water therethrough, an airtight layer configured to reduce permeability of air therethrough, other suitable material layers, and/or a combination thereof.

In other alternative embodiments, the plies 28a can be adhered to each other in their entirety, so that there is no inter-ply space 36a between the plies 28a. In other alternative embodiments, the plies 28a can be adhered to each other at locations other than, or in addition to the outer peripheries of the plies 28a.

In other alternative embodiments, the web 23 can have more than one inter-ply space 36a defined therein. For example, an alternative embodiment of the web 23 can have two inter-ply spaces 36a defined by three longitudinal inter-ply seals 30a. Two of the longitudinal inter-ply seals 30a can be located along the longitudinal edges of the web 23. The third longitudinal inter-ply seal 30a can be located at the approximate mid-point of the wall, i.e., about halfway between the longitudinal edges of wall, thereby dividing the space between the plies 28a into two inter-ply spaces 36a.

In other alternative embodiments, the web 23 can have more than three longitudinal inter-ply seals 30a, so that more than two inter-ply spaces 36a are defined within the web 23. Other alternative embodiments of the web 23 can have more than two transverse inter-ply seals 32a, to similarly divide the space between the plies 28a into more than one inter-ply space 36a. In other alternative embodiments, one or more of the inter-ply seals can extend in a direction other than the longitudinal and transverse directions. In other alternative embodiments, a small band or dot of adhesive located between the plies 28a, and inward of the longitudinal, lower, and upper edges of the web 23, can be used to further adhere the plies 28a to each other while still permitting some relative movement between the plies 28a.

In other alternative embodiments, the web 23 can be formed from a single piece of paper folded over onto itself to form the two plies 28a, and sealed along its three exposed edges. In other alternative embodiments, the web 23 can be formed from a single ply 28a.

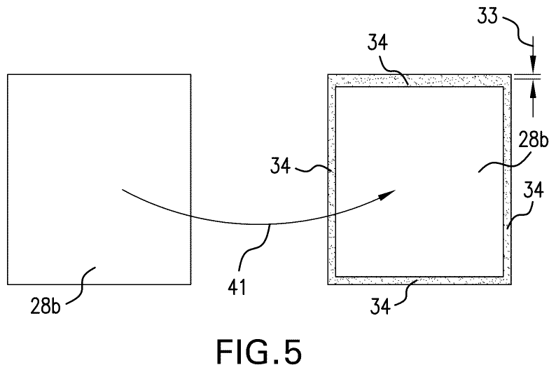

Referring to FIGS. 6-8, the plies 28b of the wall 14 are fixed to each other by two longitudinal inter-ply seals 30b and two transverse inter-ply seals 32b. The longitudinal and transverse inter-ply seals 30b, 32b are formed from the adhesive material 34. The adhesive material 34 is applied to a first of the plies 28b as shown in FIG. 5. The other ply 28b is aligned with the first ply 28b and brought into contact with the adhesive material 34, as denoted by the arrow 41 in FIG. 5, to form the longitudinal and transverse inter-ply seals 30b, 32b, thereby fixing the plies 28b to each other to form the wall 14.

Each longitudinal inter-ply seal 30b is located along a corresponding longitudinal, or side edge of the wall 14. The longitudinal inter-ply seals 30b can be offset from the side edge of the wall 14 in alternative embodiments. The upper end of each longitudinal inter-ply seal 30b can be offset from the upper edge of the wall 14. The offset distance can be, for example, about ⅛ inch to about ½ inch. The longitudinal inter-ply seals 30b are continuous. The longitudinal inter-ply seals 30b can be non-continuous in alternative embodiments.

One of transverse inter-ply seals 32b is located along the lower edge of the wall 14, and extends between the longitudinal inter-ply seals 30b. The transverse inter-ply seal 32b can be offset from the lower edge of the wall 14 in alternative embodiments. The other transverse inter-ply seal 32b can be offset from the upper edge of the wall 14, and extends between the longitudinal inter-ply seals 30b. The offset distance can be about equal to the offset distance of the longitudinal inter-ply seals 30b from the upper edge of the wall 14, e.g., about ⅛ inch to about ½ inch. The offset distance of the transverse inter-ply seal 32b and the longitudinal inter-ply seals 30b from the upper edge of the wall 14 is denoted in FIG. 5 by the refence character 33. The offset of the longitudinal and transverse inter-ply seals 30b, 32b from the upper edge of the wall 14 allows the upper portion of the wall 14 to be folded downward, as shown in FIG. 8.

The transverse inter-ply seals 32b are continuous. The transverse inter-ply seals 32b can be non-continuous in alternative embodiments. In other alternative embodiments, the transverse inter-ply seals 32b can extend across the entire width of the wall 14, and the longitudinal inter-ply seals 30b can extend between the transverse inter-ply seals 32b.

The longitudinal and transverse inter-ply seals 30b, 32b border, and help to define an interlayer region, or inter-ply space 36b between the two plies 28b of the wall 14. The inter-ply space 36b is visible in FIGS. 7 and 8.

The plies 28b face each other each other across the inter-ply space 36b, but are not adhered to each other in the inter-ply space 36b. Also, the inter-ply space 36b is sufficiently empty such that the plies 28b can abut and otherwise contact each other within the inter-ply space 36b, and can slide in relation to each other within the inter-ply space 36b. For example, the inter-ply space 36b can be completely empty, i.e., the inter-ply space 36b can be completely devoid of any filler or other material.

The above discussion of possible alternative embodiments of the web 23 applies equally to the wall 14.

The inter-ply seals of the web 23 and the wall 14 can extend in directions other than the longitudinal and transverse directions in alternative embodiments. Also, the inter-ply seals can extend non-linearly in alternative embodiments.

The multi-ply construction of the web 23 and the wall 14, and the absence of a fixed mechanical connection between the plies 28a, 28b within the respective inter-ply spaces 36a, 36b can enhance the ability of the envelope 10 to withstand tearing or puncturing. More specifically, in the event of a tear or puncture in one of the plies 28a, 28b, the underlying envelope pocket 15 of the envelope 10, and the item 114 residing in the envelope pocket 15, will remain enclosed due to the presence of the intact, i.e., undamaged, ply 28a, 28b in the same wall 12, 14.

Also, although the tear or puncture may propagate along the damaged ply 28a, 28b, it will not necessarily propagate to the intact ply 28a, 28b because the longitudinal inter-ply seals 30a, 30b and/or the transverse inter-ply seals 32a, 32b will act as a stop that prevents the tear or puncture from propagating past, or through the longitudinal inter-ply seals 30a, 30b or the transverse inter-ply seals 32a, 32b. Thus, the envelope pocket 15 will remain intact and the item 114 held therein will remain in the envelope pocket 15 even when the tear or puncture propagates across the most or all of the damaged ply 28a, 28b.

Also, the multi-ply configuration of the web 23 and the wall 14 can facilitate the use of lower basis-weight paper than otherwise would be possible, providing the web 23 and the wall 14 with greater flexibility than they otherwise might have, while maintaining the strength and tear resistance needed for a particular application. For example, the plies 28a, 28b of the respective web 23 and wall 14 can be formed from relatively low basis-weight paper, such as two plies of 40-pound paper, in lieu of a single ply of 90-pound paper.

The web 23 and the wall 14 can be fixed to each other as follows, to form the assembled container unit 11. A sealing element in the form of an adhesive material 35 is applied to the outer surface of one of the plies 28a of the web 23, along the side edges thereof, as shown in FIG. 5. The adhesive material 35 extends between the lower edge of the web 23, and a position corresponding to the lower edge of the closure flap 16 on the assembled envelope 10. The adhesive material 35 also is applied along the lower edge of the ply 28a.

The adhesive material 35 can be a cold glue, as described above in relation to the adhesive 34. Other types of adhesive materials, and other types of sealing elements can be used in lieu of a cold glue alternative embodiments. For example, as discussed above, a cohesive material, a heat sealable material, and/or a hot-melt adhesive can be used as the sealing elements in alternative embodiments.

Following application of the adhesive material 35, the lower portion of the web 23 is folded along the lines F₁ and F₂ shown in FIG. 6, to define a first fold 37a and a second fold 37b. The first and second folds 37a, 37b form the gusset 19. The first fold 37a is folded upward, and onto the adjacent portion of the web 23. The adjacent portion of the web 23 forms part of the wall 12 of the fully formed envelope 10. The folding of the first fold 37a causes the adhesive material 35 on the sides of the first fold 37a to contact the adhesive material 35 on the respective sides of the adjacent portion of the web 23, forming longitudinal seals (not shown) that fix the first fold 37a to the adjacent portion of the web 23.

The second fold 37b is folded downward as the first fold 37a is folded upward, so that the side of the second fold 37b with the adhesive material 35 thereon faces outward. The wall 14 then is positioned so that: the lower edge of the wall 14 aligns with the lower edge of the second flap 37b, and each longitudinal edge of the wall 14 aligns with a corresponding longitudinal edge of the web 23.

The wall 14 is then brought into contact with the web 23. The adhesive material 35 extending along the lower edge of the second fold 37b contacts the portion of the wall 14 adjacent the lower edge of the second side wall 14, forming a transverse seal 40 between the second fold 37b and the wall 14. The transverse seal 40 is visible in FIG. 8. The adhesive material 35 along the sides of the second fold 37b contacts the longitudinal edge portions of the wall 14, forming longitudinal seals (not shown) between the second fold 37b and the adjacent portion of the web 23.

Also, the adhesive material 35 extending along the sides of the web 23, above the first and second folds 37a, 37b, contacts the side edge portions of the wall 14, forming longitudinal inter-wall seals 42 between the wall 12 and the wall 14. The longitudinal inter-wall seals 40 are visible in FIG. 7.

At this point, the wall 14 has been fixed to the web 23. The second 14 opposes the wall 12, and is fixed to the wall 12 by the longitudinal inter-wall seals 42. The gusset 19 is fixed to the wall 12 by the longitudinal seal between the wall 12 and the first fold 37a. The gusset 19 is fixed to the wall 14 by the longitudinal seal between the wall 14 and the second fold 37b, and by the transverse seal 40. The longitudinal inter-wall seals 42 and the transverse seal 40 border the pocket 15 defined by the walls 12, 14 and the gusset 19, and thus define a containment border.

The holes 20 subsequently can be formed in the wicketing flap 18. Alternatively, the holes 20 can be formed prior to assembly of the envelope 10.

A score line 29, visible in FIG. 8, can be placed on the web 23 between the upper end of the wall 12 and the lower end of the closure flap 16. The score line causes the underlying portion of the web 23 to act as a living hinge that allows the closure flap 16 to rotate from an open position shown in FIG. 9, to a closed position shown in FIG. 10. When in the closed position, the closure flap 16 is positioned over the outward-facing surface of the wall 14, so that the closure flap 16 closes the envelope pocket 15 and thereby retains the item 114 within the envelope pocket 15. Alternatively, the score line can be formed prior to assembly of the envelope 10.

A sealing element in the form of a band of adhesive 48 is placed on the surface of the closure flap 16 that folds onto the wall 14. The adhesive 48 can be a pressure sensitive (cold) adhesive. The adhesive 48 can be covered by a release strip 49, shown in FIGS. 8 and 9, until the envelope 10 is ready to be closed. Sealing elements other than the cold adhesive 48 can be used in alternative embodiments. For example, a cohesive material, a heat sealable material, or a hot-melt adhesive can be used in lieu of the cold adhesive.

The assembled container units 11 can be grouped into the flight 106 as discussed above, and the respective wicketing flaps 18 of the container units 11 within the flight 106 can be fixed to each other by the staples 112 or other devices as discussed above. As can be seen in FIGS. 1, 2, and 9, due to the flat configuration the container units 11, the flights 106 have a relatively compact footprint that permits the flights 106 to be shipped the packaging facility in an efficient manner.

Upon reaching the packing facility, the flights 106 can be placed on the wicket 100 with one or more other flights 106, as needed by the packing operator. The envelope 10 of each container unit 11 can be loaded manually, while the container unit 11 is on the wicket 100. To load the envelope 10, the packaging operator can pull the top of the wall 14 away from the wall 12 as depicted in FIG. 9, thereby expanding the envelope 10 from its the flat state. The flexibility of the walls 12, 14, and the gusset 19 facilitate the expansion of the envelope 10. The expansion of the envelope 10 causes the envelope pocket 15 to become defined between the walls 12, 14, with the upper edge of the wall 14 and the adjacent portion of the wall 12 defining an opening 46 to the envelope pocket 15.

The packaging operator can insert the item to be packaged 114 into the envelope pocket 15 by way of the opening 46. As shown in FIG. 9, the packaging operator then separates the envelope 10 from the wicketing flap 18 (and the flight 106) by pulling the envelope 10 so as to break the material between the perforations 22.

As discussed above, the wicketing flaps 18 of the container units 11 in each flight 106 collectively form a wicketing spine 118 through which external forces acting on the individual envelopes in the flight 106 are distributed, and transmitted to the wicket 100. The reactive force exerted by the wicket 100 likewise is exerted on, and transmitted through the wicketing spine 118. Thus, the pulling force exerted by the user to separate the wicketing flap 18 from the rest of the envelope 10, and the reactive force exerted by the wicket 100, are distributed throughout the multiple wicketing flaps 18 of the wicketing spine 118, which collectively form a relatively large surface area, rather than being concentrated solely on the wicketing flap 18 of the specific envelope 10 being separated from the flight 106. This force distribution can reduce the potential for the wicket flap 18 associated with the envelope 10 being removed from the flight 106 to tear and separate from the wicket 100 (and remain with the envelope 10), instead of properly tearing along the region of weakness provided by perforations 22.

Once the wicketing flap 18 has been separated from the rest of the envelope 10, the packaging operator can close and seal the envelope 10 (without the wicketing flap 18, which remains on the wicket 100). In particular, the packaging operator can remove the release strip 49 from the band of adhesive 48 on the closure flap 16, as depicted in FIG. 9. The packaging operator then can rotate the closure flap 16 about the score line 29 between the closure flap 16 and the wall 12, so that the closure flap 16, and the adhesive band 48 thereon, rotate over and onto the outwardly-facing surface of the wall 14 as shown in FIG. 11. The folding of the closure flap 16 closes the opening 46 to the pocket 15. The adhesive band 48 fixes the closure flap 16 to the wall 14, so that the envelope pocket 15 remains closed and the packaged item 114 is retained therein. The closure flap 16 should have a height that is sufficient to allow the closure flap 16 to cover the opening 46 in the expanded envelope 10, and to allow the adhesive band 48 to land on the outwardly-facing surface of the wall 14.

Once the flights 106 of envelopes 10 on the wicket 100 have been depleted, the packaging operator can remove the wicket 100 from the backboard 108 or other mounting apparatus. The packaging operator then can remove the wicketing flaps 18 that have remained on the wicket 100 as part of the wicketing spines 118. One or more additional flights 106 then can be loaded on the wicket 100, and the wicket 100 can be reinstalled on the backboard 108. Alternatively, another supply unit 116, made up of a wicket 100 and another set of flights 106, can be mounted on the backboard 108.

In other alternative embodiments, the web 23 and the wall 14 can be formed unitarily from a single webbing that is folded onto itself so that the wall 14 overlies the web 23. One inter-wall seal can be used to fix the overlying longitudinally-extending edges of the webbing to each other. Another inter-wall seal likewise can be used to fix the overlying transversely-extending edges of the webbing 14 to each other at the bottom end of the envelope.

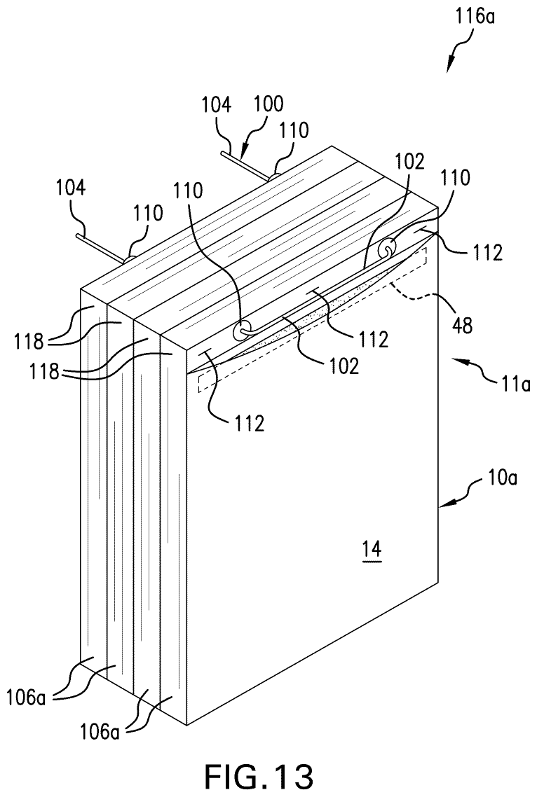

FIG. 13 depicts a supply unit 116b of container units 11a each comprising a wicketed envelope 10a and an adjoining wicketing flap 18. The container units 11a are shown arranged in flights 106a on the wicket 100. The envelopes 10a are substantially similar to the envelopes 10, with the exception that the envelopes 10a do not have a closure flap. Instead, the wall 12 of each envelope 10a directly adjoins the wicketing flap 18. The sealing element, i.e., the band of adhesive 48, can be disposed on the inwardly-facing surface of the wall 12, near the upper end of the wall 12. After the item 113 has been loaded into the envelope 10a, the release strip 49 (not shown) can be removed from the adhesive 48, and the wall 14 can be pressed into the band of adhesive 48 to fix the wall 14 to the wall 12 and thereby seal the item 114 within the envelope 10a. In alternative embodiments, the band of adhesive 48 can be disposed on the wall 14 in addition to, or in lieu of, the wall 12.

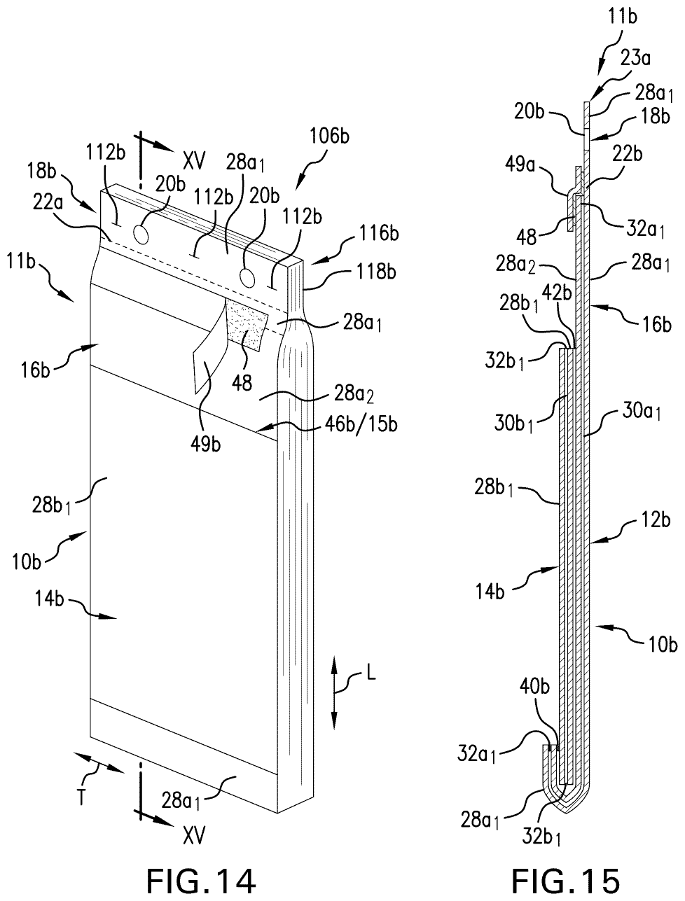

FIGS. 14-17 depict an alternative embodiment of the container unit 11 in the form of a container unit 11b. The container unit 11b is substantially similar to the container unit 11, and except where otherwise noted, the above description of the container unit 11 applies equally to the container unit 11b.

The container unit 11b comprises an envelope 10b and a wicketing flap 18b. Referring to FIG. 14, the container units 11b can be arranged in flights 106b and held on the wicket 100, as discussed above in relation to the container units 11.

The container units 11b and the wicket 100 together form a supply unit 116b of wicketed envelopes 10b. The envelopes 10b are configured to contain and hold the item to be packaged 114. As discussed below, the envelope 10b can be detached from the wicketing flap 18b manually, or using automated equipment, after the above-noted item 114 has been loaded into the envelope 10b, with the wicketing flap 18b remaining on the wicket 100.

The envelope 10b of each container unit 11b comprises a flexible wall 12b, and a flexible wall 14b fixed to the flexible wall 12b in the below-described manner. The walls 12b, 14b define a containment region in the form of an envelope pocket 15b, depicted in part in FIG. 14. The envelope pocket 15b is configured to receive and hold the item to be packaged 114.

The envelope 10b also includes a closure flap 16b. A lower end of the closure flap 16b adjoins an upper end of the wall 12b, as can be seen in FIGS. 14-16. A lower end of the wicketing flap 18b of the container unit 11b adjoins an upper end of the closure flap 16.

Directional terms such as “upper,” “lower,” “above,” “below,” etc. are used in relation to the component orientations shown in FIG. 14. These terms are used for illustrative purposes only, and are not intended to limit the scope of the claims.

The wicketing flap 18b has two holes 20a formed therein, as discussed above in relation to the wicketing flap 18 of container units 11. The above description of the holes 20 of the wicking flap 18 applies equally to the holes 20a of the wicketing flap 18.

The container units 11b within each flight 106b can be held together by, for example, one or more staples 112b, as discussed above in relation to the container units 11.

The wicketing flaps 18b of each flight 106b collectively form a wicketing spine 118b for the flight 106b. As discussed above in relation to the container units 11, the wicketing spine 118b acts as a rigid or semi-rigid structure through which external forces acting on one or more of the container units 11b can be transmitted to the wicket 100, and the reactive force exerted by the wicket 100 is distributed throughout the wicketing spine 118b.

The envelope 10b can be configured to separate from the wicketing flap 18b by the provision of a region of weakness between the closure flap 16b and the wicketing flap 18b. The region of weakness can be provided, for example, by perforations 22a similar or identical to the perforations 22 of the container units 11. In alternative embodiments, the container unit 11b can be equipped with a pull tab or other provision in lieu of the perforations 22a, to facilitate separation of the envelope 10b from the wicketing flap 18b.

In alternative embodiments, the region of weakness can be provided by features other than the perforations 22a. For example, the region of weakness can be provided by a score line. Other alternative embodiments can be configured without a line of weakness. In such embodiments, the closure flap 16b can be separated from the wicketing flap 18 by cutting, tearing, the focused application of heat, etc. In other alternative embodiments, the container unit 11b can be equipped with a pull tab or other provision in lieu of the perforations 22a.

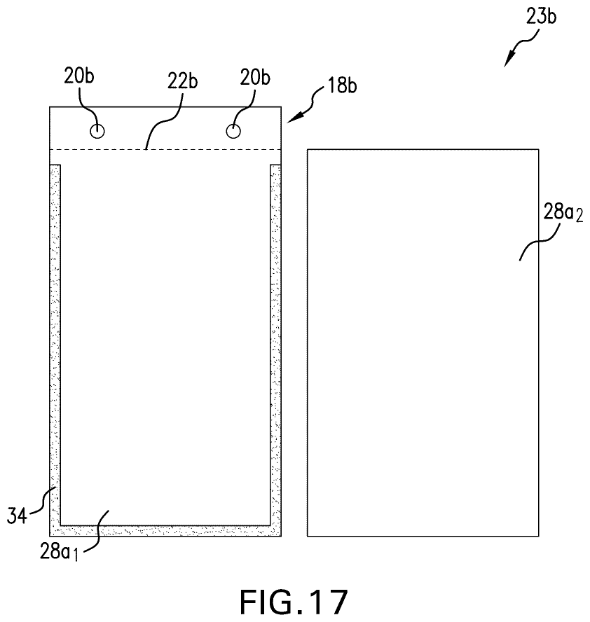

The wall 12b can be formed unitarily with the closure flap 16b and the wicketing flap 18b. The wall 12b, the closure flap 16b, and the wicketing flap 18b can be formed as a web 23a. Referring to FIGS. 15 and 17, the web 23a includes two layers. Each layer is made of a respective ply 28a₁, 28a₂ of paper. As discussed below, the plies 28a₁, 28a₂ are sized differently. More specifically, the ply 28a₂ is shorter than the ply 28a₁, so that the wicketing flap 18b has a single-layer configuration, while the wall 12b and most of the closure flap 16b each have a two-layer configuration.

The wall 14b likewise includes two layers, with each layer being formed by a single ply 28b₁ of paper. The plies 28b₁ are substantially identical. The wall 14b can be fixed to the web 23a in the below-described manner, to form the assembled envelope 10b.

The paper from which the plies 28a₁, 28a₂, 28b₁ are formed can be, for example, kraft paper having a basis weight of 40 pounds. In alternative embodiments of the packaging unit 11b, the wall 14b can have a single-layer configuration. The plies 28a₁, 28a₂, 28b₁ can be formed from paper other than kraft paper, from paper having a basis weight greater or less than 40 pounds, and from materials other than paper, such as plastic film, in alternative embodiments.

As can be seen in FIG. 17, the ply 28a₁ of the web 23b has a height, or longitudinal dimension greater that the height of the ply 28a2. As discussed below, the differing heights of the plies 28a₁, 28a₂ results in the single-layer configuration of the wicketing flap 18b.

The plies 28a₁, 28a₂ of the web 23b are fixed to each other by two longitudinal inter-ply seals 30a₁ and two transverse inter-ply seals 32a₁, visible in FIG. 15. The longitudinal and transverse inter-ply seals 30a₁, 32a₁ can be formed from a sealing element in the form of the adhesive material 34 discussed above in relation to the web 23. The adhesive material 34 is applied to a first of the plies 28a₁, 28a₂, as shown in FIG. 17 (which depicts the adhesive material 34 applied to the ply 28a₁). The other ply 28a₁, 28a₂ is aligned with the first ply 28a₁, 28a₂ and brought into contact with the adhesive material 34 to form the longitudinal and transverse inter-ply seals 30a₁, 32a₁, thereby fixing the plies 28a₁, 28a₂ to each other to form the web 23a.

In alternative embodiments, the web 23a can be formed as part of a continuous webbing containing multiple webs 23a. The individual plies 28a₁, 28a₂ within the webbing can be formed from two continuous sheets of paper fixed to each other by the adhesive material 34 applied to the sheets of paper so as to form the longitudinal and transverse inter-ply seals 30a₁, 32a₁ when the sheets are aligned brought into contact with each other. Each individual web 23a can be cut from the webbing before, or after the web 23a is joined with a corresponding wall 14b to form the envelope 10b.

The longitudinal and transverse directions are denoted by the respective arrows “L” and “T” in FIG. 14.

As noted above, the ply 28a₂ is shorter that the ply 28a₁. As can be seen in FIGS. 15 and 17, the upper edge of the ply 28a₂ is offset from the upper edge of the ply 28a₁, so that the upper edge of the ply 28a₂ is located below the perforations 22a that define the border between the wicketing flap 18b and the closure flap 16b. For example, the upper edge of the ply 28a₂ can be located about ⅜-inch below the perforations 22a, from the perspective of FIGS. 14 and 17. The upper edge of the ply 28a₂ can be approximately coincident with the perforations 22a in alternative embodiments of the container unit 11b. Thus, the wicketing flap 18b is configured as a single layer formed exclusively from the ply 28a₁, while the wall 12b and at least a portion of the closure flap 16b have a two-ply configuration formed by the plies 28a₁, 28a2.

The single-layer configuration of the wicketing flap 18b permits the associated envelope 10b to be separated from the wicketing flap 18b with less force than is needed to separate the envelope 10 from the double-ply wicking flap 18 described above, which in turn can reduce the potential for the wicketing flap 18b to tear and separate from the wicket 100 without fully separating from the envelope 10b.

Each longitudinal inter-ply seal 30a₁ is located along a corresponding longitudinal, or side edge of the web 23b. Each longitudinal inter-ply seal 30a₁ can be offset from the corresponding side edge of the web 23b in alternative embodiments. The longitudinal inter-ply seals 30a₁ extend from the respective lower edges of the plies 28a₁, 28a₂, and can be offset downwardly from the upper edge of the shorter ply 28a₂ by, for example, about ¼ inch. The longitudinal inter-ply seals 30a₁ can extend to the upper edge of the second ply 28a₂ in alternative embodiments. The longitudinal inter-ply seals 30a₁ are continuous. The longitudinal inter-ply seals 30a₁ can be non-continuous in alternative embodiments.

One of the transverse inter-ply seals 32a₁ of the web 23b extends along the respective lower edges of the plies 28a₁, 28a2. The other, or upper transverse inter-ply seal 32a₂ is offset from the upper edge of the ply 28a₂ by, for example, about ¼ inch. The upper transverse inter-ply seal 32a₂ can extend along the upper edge of the second ply 28a₂ in alternative embodiments.

The transverse inter-ply seals 32a₁ extend substantially in a transverse direction, and adjoin the longitudinal inter-ply seals 30a₁. The respective ends of the transverse inter-ply seals 32a₁ can be spaced from the adjacent longitudinal inter-ply seals 30a₁ in alternative embodiments. In other alternative embodiments, the transverse inter-ply seals 32a₁ can extend across the entire width of the web 23a, and the longitudinal inter-ply seals 30a₁ can extend between the upper and lower transverse inter-ply seals 32a₁. The transverse inter-ply seals 32a₁ are continuous. The transverse inter-ply seals 32a₁ can be non-continuous in alternative embodiments.

The adhesive material 34 can be a cold glue. Other types of adhesive materials, and other types of sealing elements can be used in lieu of a cold glue alternative embodiments. For example, the adhesive 34 can be a cohesive material, a heat sealable material, and/or a hot-melt adhesive in alternative embodiments.

The sealing element, e.g., the adhesive material 34, can be applied directly to the exposed surface of the ply 28a₁ (or the ply 28a2) by suitable known methods. Alternatively, the sealing element can be applied as a tape, such as a double-sided tape, or by other suitable methods.

The longitudinal and transverse inter-ply seals 30a₁, 32a₁ of the web 23b border, and help to define an interlayer region, or inter-ply space (not shown) between the plies 28a₁, 28a₂ of the web 23a, as discussed above in relation to the envelope 10.

The plies 28a₁, 28a₂ face each other each other across the inter-ply space, but are not adhered to each other in the inter-ply space. Also, the inter-ply space is sufficiently empty such that the plies 28a₁, 28a₂ can abut and otherwise contact each other within the inter-ply space, and can slide in relation to each other within the inter-ply space. For example, the inter-ply space can be completely empty, i.e., the inter-ply space can be completely devoid of any filler or other material.

In alternative embodiments, a cushioning, padding, and/or thermally-insulating material, or other types of expandable and non-expandable materials can be disposed in the inter-ply space within the web 23b, as discussed above in relation to the envelope 10.

One or both of the plies 28a₁, 28a₂ can include one or more functional layers positioned thereon, as discussed above in relation to the envelope 10.

In other alternative embodiments, the plies 28a₁, 28a₂ can be adhered to each other in their entirety, so that there is no inter-ply space between the plies 28a₁, 28a2. In other alternative embodiments, the plies 28a₁, 28a₂ can be adhered to each other at locations other than, or in addition to the outer peripheries of the plies 28a₁, 28a2.

In other alternative embodiments, the web 23a can have more than one inter-ply space defined therein. For example, an alternative embodiment of the web 23a can have two inter-ply spaces defined by three longitudinal inter-ply seals 30a₁. Two of the longitudinal inter-ply seals 30a₁ can be located along the longitudinal edges of the web 23a. The third longitudinal inter-ply seal 30a₁ can be located at the approximate mid-point of the wall, i.e., about halfway between the longitudinal edges of wall, thereby dividing the space between the plies 28a₁, 28a₂ into two inter-ply spaces.

In other alternative embodiments, the web 23a can have more than three longitudinal inter-ply seals 30a₁, so that more than three inter-ply spaces 36a₁ are defined within the web 23a. Other alternative embodiments of the web 23a can have more than two transverse inter-ply seals 32a₁, to similarly divide the space between the plies 28a₁, 28a₂ into more than one inter-ply space. In other alternative embodiments, one or more of the inter-ply seals can extend in a direction other than the longitudinal and transverse directions. In other alternative embodiments, a small band or dot of adhesive located between the plies 28a₁, 28a₂, and inward of the longitudinal, lower, and upper edges of the web 23a, can be used to further adhere the plies 28a₁, 28a₂ to each other while still permitting some relative movement between the plies 28a₁, 28a2.

In other alternative embodiments, the web 23a can be formed from a single piece of paper folded over onto itself to form the two plies 28a₁, 28a₂, and sealed along its three exposed edges.

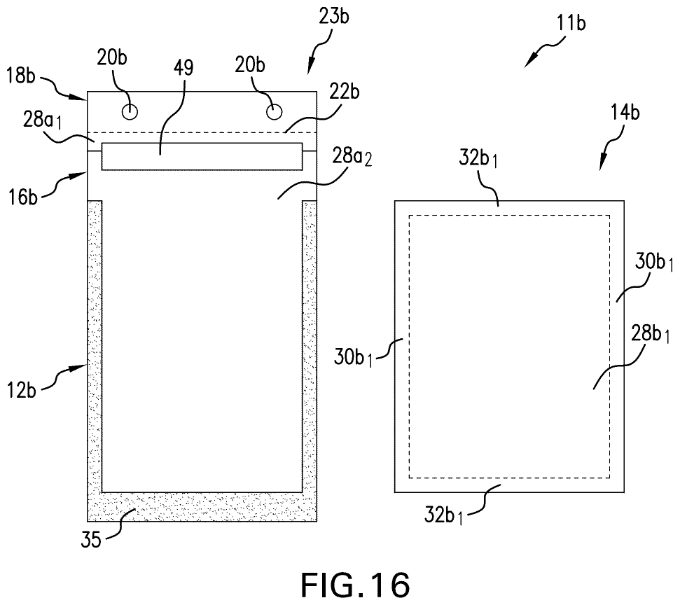

Referring to FIGS. 15 and 16, the plies 28b₁ of the wall 14b are fixed to each other by two longitudinal inter-ply seals 30b₁ and two transverse inter-ply seals 32b₁ (the longitudinal and transverse inter-ply seals 30b1, 32b₁ are depicted in phantom in FIG. 16). The longitudinal and transverse inter-ply seals 30b1, 32b₁ are formed from the adhesive material 34. The adhesive material 34 is applied to a first of the plies 28b1. The other ply 28b₁ is aligned with the first ply 28b₁ and brought into contact with the adhesive material 34 to form the longitudinal and transverse inter-ply seals 30b1, 32b1, thereby fixing the plies 28b₁ to each other to form the wall 14.

Each longitudinal inter-ply seal 30b₁ of the wall 14b is located along a corresponding longitudinal, or side edge of the wall 14b. The longitudinal inter-ply seals 30b₁ can be offset from the side edges of the wall 14b in alternative embodiments. The upper end of each longitudinal inter-ply seal 30b₁ can be located along the upper edge of the wall 14b. The upper end of each longitudinal inter-ply seal 30b₁ can be offset from the upper edge of the wall 14b in alternative embodiments. The longitudinal inter-ply seals 30b₁ are continuous. The longitudinal inter-ply seals 30b₁ can be non-continuous in alternative embodiments.

One of transverse inter-ply seals 32b₁ of the wall 14b is located along the respective lower edge of the wall 14b, and extends between the longitudinal inter-ply seals 30b1. The lower transverse inter-ply seal 32b₁ can be offset from the lower edge of the wall 14b in alternative embodiments. The upper transverse inter-ply seal 32b₁ can be offset from the upper edge of the wall 14b by, for example, about 1/16 inch. The upper transverse inter-ply seal 32b1 can extend along the upper edge of the wall 14b in alternative embodiments of the envelope 10b.

The transverse inter-ply seals 32b₁ are continuous. The transverse inter-ply seals 32b1 can be non-continuous in alternative embodiments.

The transverse inter-ply seals 32b₁ extend substantially in a transverse direction, and adjoin the longitudinal inter-ply seals 30b1. The respective ends of the transverse inter-ply seals 32b₁ can be spaced from the adjacent longitudinal inter-ply seals 30a₁ in alternative embodiments. In other alternative embodiments, the transverse inter-ply seals 32b₁ can extend across the entire width of the web 23a, and the longitudinal inter-ply seals 30b₁ can extend between the upper and lower transverse inter-ply seals 32b1. The transverse inter-ply seals 32b1 are continuous. The transverse inter-ply seals 32b₁ can be non-continuous in alternative embodiments.

The longitudinal and transverse inter-ply seals 30b1, 32b₁ border, and help to define an interlayer region, or inter-ply space between the plies 28b₁ of the wall 14b.

The plies 28b₁ face each other each other across the inter-ply space, but are not adhered to each other in the inter-ply space. Also, the inter-ply space is sufficiently empty such that the plies 28b₁ can abut and otherwise contact each other within the inter-ply space, and can slide in relation to each other within the inter-ply space. For example, the inter-ply space can be completely empty, i.e., the inter-ply space can be completely devoid of any filler or other material.

The above discussion of possible alternative embodiments of the web 23b applies equally to the wall 14b.

The inter-ply seals of the web 23b and the wall 14b can extend in directions other than the longitudinal and transverse directions in alternative embodiments. Also, the inter-ply seals can extend non-linearly in alternative embodiments.

The web 23b and the wall 14b can be fixed to each other as follows, to form the assembled container unit 11b. A sealing element in the form of the above-noted adhesive material 35 is applied to the outer surface of the ply 28a₂ of the web 23a, along the side edge portions thereof, as show in in FIG. 16. The adhesive material 35 extends from the lower edge of the ply 28a₂, to a position offset downwardly from the lower edge of the closure flap 16 by about ¼-inch. The adhesive material 35 also is applied along the entire length of the lower edge portion of the ply 28a2.

The adhesive material 35 can be a cold glue, as described above in relation to the adhesive 34. Other types of adhesive materials, and other types of sealing elements can be used in lieu of a cold glue alternative embodiments. For example, a cohesive material, a heat sealable material, and/or a hot-melt adhesive can be used as the sealing element in alternative embodiments.

Following application of the adhesive material 35, the wall 14b is aligned with the web 23b so that the lower edge of the wall 14b is offset upwardly from the lower edge of the web 23b by, for example, about ½-inch, and the ply 28a₂ of the web 23a faces the inwardly-facing ply 28b₁ of the wall 14b. The wall 14b then is brought into contact with the web 23b. The adhesive material 35 extending along the side edge portions of the ply 28a₂ contacts the corresponding side edge portions of the inwardly-facing ply 28b₁ of the wall 14b, forming longitudinal inter-wall seals 42a between the web 23a and the wall 14b.

As this point, the wall 14b does not overlap the lowermost portion of the web 23a due to the above-noted offset between the respective lower edges of the wall 14b and the web 23b. The lowermost portion of the web 23b is folded over and onto the outwardly-facing surface of the outer ply 28b₁ of the wall 14b, so that the adhesive material 35 along the lower edge portion of the ply 28a₂ of the web 23a contacts the outer ply 28b1. The adhesive material 35 along the lower edge portion of the ply 28a₂ forms a transverse inter-wall seal 40b between the web 23b and the wall 14b. The transverse inter-wall seal 40b fixes the folded portion of the web 23b to the outwardly-facing surface of the outer ply 28b₁ of the wall 14b, thereby maintaining the bottom of the envelope 10b in a closed state.

At this point, the wall 14b has been fixed to the web 23b. The second wall 14b opposes the wall 12b, and is fixed to the wall 12b by the longitudinal inter-wall seals 42b extending along the sides of the packaging unit 11b, and the transverse inter-wall seal 40b extending along the bottom of the packaging unit 11b. The wall 12b is defined by the portion of the web 23b between the bottom fold in the web 23a, and the closure flap 16b. The border between the upper edge of the closure flap 16b and the lower edge of the wicking flap 18b is defined by the perforations 22a. The upper edge of the wall 14b opposes the upper edge the wall 12b and the lower edge of the closure flap 16b. The longitudinal inter-wall seals 42b and the transverse seal 40b border the pocket 15b defined by the wall 12b and the wall 14b, and thus define a containment border. Prior to sealing of the envelope 10b, as discussed below, the envelope pocket 15b is accessible by way of the opening 46b defined between the wall 12b and the wall 14b.

Alternative embodiments the packaging unit 11b can be formed without the bottom fold in the web 23b. Also, alternative embodiments the packaging unit 11b can be formed with side and/or bottom gussets between the walls 12b, 14b. In other alternative embodiments, the upper ends of the longitudinal inter-wall seals 42b can be offset downwardly from the upper edge of the wall 14b by a distance sufficient to permit the upper end of the wall 14b to be folded inwardly, toward the envelope pocket 15b.

The holes 20b subsequently can be formed in the wicketing flap 18b. Alternatively, the holes 20b can be formed prior to assembly of the packaging unit 11b.

The closure flap 16b can be folded over, and onto the outwardly-facing surface of the wall 14b after the item 114 has been loaded into the envelope pocket 15b, to close the opening 46b so that the item 114 is retained in the envelope pocket 15b. As can be seen in FIGS. 14 and 15, a sealing element in the form of a band of the above-noted adhesive 48 is placed on the surface of the closure flap 16b that folds onto the wall 14b. The adhesive 48 can be a pressure sensitive (cold) adhesive. The adhesive 48 can be covered by a release strip 49b until the envelope 10b is ready to be closed. Sealing elements other than the cold adhesive 48 can be used in alternative embodiments. For example, a heat sealable material or a hot-melt adhesive can be used in lieu of the cold adhesive. Also, the band of adhesive 48 can be placed on the outwardly-facing surface of the wall 14b instead of the closure flap 16b in alternative embodiments.

In alternative embodiments, a score line can be placed on the web 23b between the upper end of the wall 12b and the lower end of the closure flap 16b, so that the underlying portion of the web 23b can act as a living hinge that facilitates rotation of the closure flap 16b. to rotate from an open position shown in FIG. 9, to a closed position shown in FIG. 10.

The assembled container units 11b can be grouped into the flight 106b as discussed above, and the respective wicketing flaps 18b of the container units 11b within the flight 106b can be fixed to each other by the staples 112b or other devices as discussed above.

Upon reaching the packing facility, the flights 106b can be placed on the wicket 100, and the envelopes 10b of the packaging units 11b can be loaded with the items 114 and separated from their respective wicketing flaps 18b, as discussed above in relation to the packaging units 11b. As noted above, the single-ply configuration of the wicketing flap 18b reduces the force needed to separate the closure flap 16b from the wicketing flap 18b along the line of perforations 22a, which in turn can reduce the potential for the wicketing flap 18b to be torn off the wicket 100 instead of fully separating from the closure flap 16b.

Once the wicketing flap 18b has been separated from the rest of the packaging unit 11b, the packaging operator can close and seal the envelope 10b as discussed above.

Although the present solution has been illustrated and described with respect to one or more implementations, equivalent alterations and modifications will occur to others skilled in the art upon the reading and understanding of this specification and the annexed drawings. In addition, while a particular feature of the present solution may have been disclosed with respect to only one of several implementations, such feature may be combined with one or more other features of the other implementations as may be desired and advantageous for any given or particular application. Thus, the breadth and scope of the present solution should not be limited by any of the above described embodiments. Rather, the scope of the present solution should be defined in accordance with the following claims and their equivalents.

Although the present solution has been illustrated and described with respect to one or more implementations, equivalent alterations and modifications will occur to others skilled in the art upon the reading and understanding of this specification and the annexed drawings. In addition, while a particular feature of the present solution may have been disclosed with respect to only one of several implementations, such feature may be combined with one or more other features of the other implementations as may be desired and advantageous for any given or particular application. Thus, the breadth and scope of the present solution should not be limited by any of the above described embodiments. Rather, the scope of the present solution should be defined in accordance with the following claims and their equivalents.

What is claimed is:

1. A flight of wicketed envelopes, the flight comprising:
a plurality of container units, each including:
an envelope, comprising:
first flexible wall;
a second flexible wall overlying the first flexible wall and fixed to the first flexible wall about at least a portion of a pocket border, which pocket border encloses a pocket defined between the walls and configured and dimensioned to contain an item, at least one of the walls defining a pocket opening allowing access to the pocket from an exterior of the envelope for loading the item into the pocket; and
a wicketing flap removably connected to the envelope;
wherein the wicketing flaps of the plurality of container units are affixed to each other to cumulatively define a wicketing spine, such that the spine has an elevated rigidity and resistance to tearing in relation to a single one of the wicketing flaps.

2. The flight of wicketed envelopes of claim 1, wherein the spine is configured to distribute at least a portion of a force exerted on one of the container units to the wicketing flaps of at least some of the other container units.

3. The flight of wicketed envelopes of claim 2, wherein the force is a pulling force.

4. The flight of wicketed envelopes of claim 3, wherein:
the spine is configured to be held on a wicket; and
the wicketing flap is configured to detach from the first flexible wall in response to the pulling force, the pulling force being exerted on one or both of the first and second flexible walls in a direction away from the wicket.

5. The flight of wicketed envelopes of claim 1, wherein the wicketing flap is configured to engage a wicket to suspend the container unit from the wicket, and to remain engaged with the wicket upon separating from the envelope.

6. The flight of wicketed envelopes of claim 1, wherein the wicketing flap is removably connected to the first wall.

7. The flight of wicketed envelopes of claim 1, wherein the wicketing flaps of the plurality of container units are configured to be stacked to further cumulatively define the wicketing spine.

8. The flight of wicketed envelopes of claim 1, further comprising at least five of the container units.

9. The flight of wicketed envelopes of claim 1, wherein:
the envelope further comprises: a closure flap that adjoins, and is disposed between the first flexible wall and the wicketing flap; and a sealing element disposed on at least one of the closure flap and the second flexible wall;
the wicketing flap is removably connected to the closure flap;
the closure flap is configured to rotate from a first position, to a second position at which the closure flap covers the pocket opening to retain the item in the pocket; and
the sealing element is configured to form a closure seal that fixes the closure flap to the second flexible wall when the closure flap is in the second position.

10. The flight of wicketed envelopes of claim 9, wherein:
the pocket is sealed on a first, a second, and a third side of the pocket, and is open on a fourth side of the pocket when the closure flap is in the first position; and
the pocket is sealed on the first, second, third, and fourth sides of the pocket when the closure flap is fixed in the second position by the closure seal.

11. The flight of wicketed envelopes of claim 1, wherein:
the envelope further comprises a sealing element disposed on at least one of the first flexible wall and the second flexible wall; and
the sealing element is configured to form a closure seal that fixes the first flexible wall to the second flexible wall.

12. The flight of wicketed envelopes of claim 11, wherein:
the pocket is sealed on a first, a second, and a third side of the pocket, and is open on a fourth side of the pocket prior to formation of the closure seal; and
the pocket is sealed on the first, second, third, and fourth sides of the pocket when the first flexible wall is fixed to the second flexible wall by the closure seal.

13. The flight of wicketed envelopes of claim 2, wherein:
the wicketing flaps of the plurality of container units are connected by at least one of a staple, a clamp, and an adhesive; and
the at least one of a staple, a clamp, and an adhesive is configured to transmit at least a portion of the force to the wicketing flaps of the other container units.

14. The flight of wicketed envelopes of claim 1, wherein at least one of the first and second flexible walls comprises paper.

15. The flight of wicketed envelopes of claim 1, wherein the wicketing flap has at least two of holes formed therein, the holes being configured to receive a respective first and second leg of the wicket.

16. The flight of wicketed envelopes of claim 1, wherein:
the wicketing spine is further configured to hold each of the wicketing flaps in contact with one or more adjacent wicketing flaps within the flight of wicketed flaps.

17. The flight of wicketed envelopes of claim 1, wherein a region of weakness is defined between the wicketing flap and the envelope, the region of weakness configured to facilitate separation of the wicketing flap from the envelope.

18. A container unit configured to be held on a wicket, comprising:
an envelope, comprising:
a first flexible wall;
a second flexible wall overlying the first flexible wall and fixed to the first flexible wall about at least a portion of a pocket border, which pocket border encloses a pocket defined between the walls and configured and dimensioned to contain an item, at least one of the walls defining a pocket opening allowing access to the pocket from an exterior of the envelope for loading the item into the pocket; and
a wicketing flap removably connected to the envelope.

19. A supply unit of container units configured to be held on a wicket, comprising:
a wicket; and
a plurality of the container units of claim 18.

20. A method of packaging an item, comprising:
providing a container unit configured to be held on a wicket, the container unit comprising:
an envelope comprising: a first flexible wall; a second flexible wall opposing the first flexible wall, the first and second flexible walls defining a pocket therebetween; and a sealing element configured to from a closure seal that maintains the pocket opening in a closed condition; and
a wicketing flap connected to the closure flap;
suspending the container unit from a wicket by way of the wicketing flap;
loading an item into the pocket;
detaching the envelope from the wicketing flap; and
forming the closure seal.
